(19) United States
(12) Patent Application Publication
(10) Pub. No.: US 2018/0246217 A1
(43) Pub. Date: Aug. 30, 2018

(54) Method for calibrating a GNSS antenna of a vehicle

(71) Applicant: Geo++ GmbH, Garbsen (DE)

(72) Inventor: Gerhard Wuebbena, Garbsen (DE)

(21) Appl. No.: 15/902,419

(22) Filed: Feb. 22, 2018

(30) Foreign Application Priority Data
Feb. 24, 2017 (DE) 10 2017 103 894.9

(51) Int. Cl. G01S 19/23; G01S 19/40

(52) U.S. Cl. CPC G01S 19/235; G01S 19/40

(57) ABSTRACT

The invention relates to a method for calibrating a GNSS antenna of a vehicle, wherein a calibration process is performed that involves the vehicle being moved such that the horizontal and/or vertical orientation of the vehicle changes, a respective elevation- and azimuth-dependent error correction for the GNSS antenna being ascertained for different horizontal and/or vertical orientations.

The invention relates to a method for calibrating a GNSS antenna of a vehicle. The invention likewise relates to a method for determining the position of a vehicle by means of a GNSS antenna that has been calibrated using the method according to the invention.

The development of satellite navigation systems (GNSS: Global Navigation Satellite System), such as GPS, Galileo or Glonass, for example, has created the possibility of being able to very precisely ascertain the position of mobile apparatuses, such as vehicles or electronic hand-held devices, for example, anywhere in the world. This allows applications such as automatic route navigation or autonomous driving, since reliable and precise position finding for the vehicles is a substantial basic prerequisite for such technologies.

In a satellite navigation system, a multiplicity of satellites are in a prescribed orbit around the earth and continually transmit applicable position signals (GNSS signals) that can be received by a signal receiver (GNSS receiver). Such a signal receiver has a GNSS antenna in order to render the radio-based position signals receivable. Computation of the signal propagation time of the individual received GNSS signals can then be used to compute the distance from the GNSS receiver to the respective GNSS satellite, so that if there is a sufficient number of satellites (sufficient precision in four satellites) and the respective distance thereof from the GNSS receiver has been computed (having regard to the current position of the respective GNSS satellites on their orbits), the position of the GNSS receiver can then be ascertained by computing the point of intersection of the spheres defined by the distance measurement around the respective satellite.

The precision for the position finding is dependent on three factors in this case. First, satellite-influenced errors exist that have their origin in the satellite context itself. These are clock errors in the satellites or orbit errors in the satellite on its orbit, for example. Secondly, signal-influenced errors exist that have their origin in the passage of the signals through the atmospheric layers of the earth, such as the ionosphere, for example. As such, it is known, by way of example, that when a GNSS signal passes through the troposphere and ionosphere the GNSS signals are influenced in terms of their signal speed (propagation time of the signals), which results in a precision error for propagation time computation based on a fixed value for the signal speed. Finally, precision during ascertainment of the position is also dependent on an antenna-influenced error that results from the interrelation of the antenna with other, disturbing influences around the antenna and is influenced by the antenna itself.

Antenna-influenced errors during GNSS position finding result in an error in the GNSS distance measurement (pseudoranges and phase ranges) that can be corrected based on the knowledge of these systematic antenna errors, however, which eliminates or at least reduces the antenna-influenced position error. Errors in the distance measurements from GNSS satellites to GNSS antennas result in large position errors particularly if the errors are systematically dependent on the satellite position relative to the reception antenna (characterized by the vertical angle elevation and the horizontal angle azimuth). In precise GNSS positioning, an elevation- and azimuth-dependent correction for the phase measurement (phase ranges) is therefore routinely made that has been produced by calibrating the GNSS antenna used in specifically designed devices. By contrast, corrections are typically not made to the code measurements (pseudoranges).

These calibrations are performed for specific geodetic antennas that, ideally, are a long way from disturbing objects that can cause disturbances by virtue of multipath effects or electromagnetic coupling.

On vehicles, such as motor vehicles or rail vehicles, for example, on the other hand, the GNSS antennas are for the most part mounted directly on or in the outer shell of the vehicle, which means that large, for the most part metallic, objects are at a short distance from the actual antennas (large and short relate to the comparison with the typical GNSS wavelengths of 19 cm to 26 cm). These objects therefore couple strongly to the installed GNSS antenna and can cause correspondingly large elevation- and azimuth-dependent errors both for the phase measurements and for the code measurements, specifically even if the GNSS antenna has been calibrated beforehand in a specific device outside the vehicle.

DE 10 2008 045 618 A1 discloses a method and an apparatus for calibrating sensors to a vehicle, with sensor position data for the sensor to be calibrated, on the one hand, and model position data therefor being ascertained. A comparison between the model-based sensor positions and the sensor positions measured by the sensor then allows the sensor to be calibrated as appropriate. The model-based sensor positions are ascertained based on other sensor data in this case.

Zeimetz, P. et al. “Berücksichtigung von Antennenkorrekturen bei GNSS-Anwendungen” [Consideration of antenna corrections for GNSS applications] in: DVW-Merkblatt, Wißner-Verlag, Augsburg, 2011, 01-2011, pages 1-10, describes pointers in regard to the antenna correction for GNSS applications. This involves disclosing, inter alia, that, besides laboratory calibrations, antenna calibrations in the field can also be performed, for which purpose the antennas are rotated and possibly tipped over in order to compute an antenna correction.

Bilich, A., Mader, G. L., “GNSS Absolute Antenna Calibration at the National Geodetic Survey, Proceedings of the 23rd International Technical Meeting of The Satellite Division of the Institute of Navigation (ION GNSS 2010), Portland, Oreg., September 2010, pp. 1369-1377, discloses a method for absolute GNSS antenna calibration, wherein the antenna in this case is mounted on a robot arm and moved during the measurement in order to determine the applicable phase center variations.

It is therefore an object of the present invention to provide an improved method for calibrating and an improved method for determining the position by means of a GNSS antenna that allow the disturbing influences of a vehicle on the permanently installed GNSS antenna to be eliminated by using the calibration for the position determination.

The object is achieved according to the invention by means of the method according to claim 1 and also the method according to claim 8 and the apparatus according to claim 10.

According to claim 1, a method for calibrating a GNSS antenna of a vehicle is proposed, wherein first of all a vehicle is provided that has a vehicle-based GNSS device having a GNSS antenna permanently installed in the vehicle. The GNSS antenna may in this case be permanently installed such that the GNSS antenna is mounted in or on the outer shell of the vehicle. In this context, permanently installed means that the position of the GNSS antenna relative to the vehicle is unalterable, so that a movement of the GNSS antenna relative to a satellite is possible only as a result of a movement of the vehicle itself.

Vehicles within the meaning of the present invention may be any kinds of vehicles provided in particular for transporting human beings and material. Vehicles within the meaning of the present invention are in particular road vehicles, such as automobiles, trucks or motorcycles, for example. Vehicles within the meaning of the present invention may alternatively be rail vehicles, such as locomotives, for example, ships and/or aeroplanes.

According to the invention, a calibration process is performed in order to calibrate the GNSS antenna permanently installed in the vehicle. The process step of calibration is in this case a measurement process for reliably reproducibly detecting and documenting the discrepancy in the GNSS antenna. The result of the calibration process is a data record that includes a multiplicity of error corrections (for different vertical and horizontal angles) in order to be able to eliminate or reduce the antenna-influenced and systematic error in the GNSS antenna for the GNSS positioning, depending on the application.

During the calibration process, the vehicle is moved, so that the horizontal and/or vertical orientation of the vehicle changes, a respective elevation- and azimuth-dependent error correction for the GNSS antenna being computed for different horizontal and/or vertical orientations of the vehicle by a computation unit on the basis of GNSS signals of a GNSS satellite that are received in the respective horizontal and/or vertical orientation of the vehicle, in order to be able to correct an antenna-influenced elevation- and azimuth-dependent error for the GNSS position finding.

A core concept of the present invention in this case is to consider the vehicle as a whole as an extended antenna and to perform calibration of this whole vehicle and then to use this calibration for error correction on the GNSS antenna for the GNSS positioning of the vehicle.

In order to ascertain and to be able to store an appropriate error correction for different vertical and horizontal angles between satellite and GNSS antenna, the whole vehicle with its permanently installed GNSS antenna is moved such that it adopts different horizontal and/or vertical orientations, an appropriate calibration then being performed for corresponding horizontal and/or vertical orientations, so that a respective elevation- and azimuth-dependent error correction is obtained for the vertical and horizontal angles between GNSS antenna and satellite that arise from the applicable horizontal and/or vertical orientation. The elevation- and azimuth-dependent error correction can be ascertained using known calibration methods for GNSS antennas in this case, as is performed for pure GNSS antennas on moving robots, for example.

The result is that respective elevation- and azimuth-dependent error corrections for the GNSS antenna are then available for different vertical and horizontal angles, so that, based on knowledge of the horizontal and/or vertical orientation of the vehicle and the respective position of the satellite, a vertical angle and a horizontal angle can be ascertained that can then be taken as a basis for making the applicable elevation- and azimuth-dependent error correction, ascertained beforehand, for the GNSS positioning.

In one advantageous embodiment, the computation unit computes an elevation- and azimuth-dependent error correction for the phase measurement and/or code measurement for the GNSS position finding, so that the applicable elevation- and azimuth-dependent error correction can be made for the phase measurement and/or code measurement, and hence the applicable distance measurement can be corrected.

In a further advantageous embodiment, the vehicle is permanently mounted on a movable platform and then moved by means of the movable platform, the moving platform being able to be configured such that the vehicle is moved such that either only the horizontal orientation changes, only the vertical orientation of the vehicle changes, or both the horizontal and the vertical orientation of the vehicle can be altered.

In the simplest case, the movable platform is a rotating platform that is used to alter just the horizontal orientation of the vehicle by virtue of a rotation about its own axis. If the vehicle is rotated about its own axis by means of the platform for a certain period of time, for example for several hours (preferably 4 to 8 hours), then over time not only the horizontal angle in regard to the satellite changes on account of the rotation of the vehicle about its own axis, but also the vertical angle, since GNSS satellites move on an orbit around the earth over the period of time and hence carry out a relative movement vis-á-vis the vehicle that results in a change in the vertical angle. This relative movement of the satellites on their orbit, without alteration of the vertical orientation of the vehicle, results in a change in the vertical angle over time, so that a complete elevation- and azimuth-dependent error correction for the GNSS antenna can be ascertained over the calibration period by virtue of the rotation of the vehicle about its own axis. The reason is that respective corresponding GNSS signals are received for different vertical and horizontal angles in this time, on the basis of which signals an elevation- and azimuth-dependent error correction can then be computed for the respective vertical and horizontal angle.

In a further advantageous embodiment, the vehicle can also be moved along a predetermined path, for example by virtue of predefined movement patterns being traveled along over a certain period. Such movement patterns may be circles or figures of eight, for example, along which the vehicle is moved for several hours, as a result of which respective elevation- and azimuth-dependent error corrections can be ascertained for different vertical angles and for different horizontal angles in this case too.

In a further advantageous embodiment, it is finally also conceivable for the vehicle to be moved along an undetermined path, which can take place as a result of a test drive or during normal operation, for example. However, in this exemplary embodiment, the calibration process would take much longer, since it is not clearly defined from the outset that the GNSS antenna will adopt all of the vertical and horizontal angles relative to the satellite, which means that this cannot completely ensure that a respective elevation-and azimuth-dependent error correction is also available for all of the vertical and horizontal angles. Moreover, it is preferable in this case for a large-area correction data service to be used in order to be able to filter out in particular atmospherically influenced errors in the GNSS signals. Since these atmospherically influenced errors are dependent on the local position, a large-area correction data service is very advantageous during normal driving operation.

Advantageously, the calibration process can be carried out such that the horizontal and/or vertical orientation and also the position of the vehicle are ascertained by means of the vehicle-based GNSS device of the vehicle during moving of the vehicle, and the elevation- and azimuth-dependent error correction for the GNSS antenna is ascertained by a computation unit on the basis of the respective horizontal or vertical orientation of the vehicle ascertained by the GNSS device of the vehicle, the ascertained position of the vehicle and the applicable satellite position relative to the GNSS antenna.

After the calibration process, it is then advantageously possible for the ascertained elevation- and azimuth-dependent error corrections for the GNSS antenna to be stored in an error correction memory of the GNSS device, so that the GNSS device can resort to these error corrections for calibrating the GNSS antenna during position determination.

The best result is obtained if a reference station or a correction service (multiple reference stations) is used for the calibration in order to be able to remove the satellite-influenced errors (errors resulting from satellite orbits, satellite clocks and atmospheric influences) from the received signals, so that only the antenna-influenced error remains. Accordingly, it is particularly advantageous if satellite-influenced errors in the GNSS signals (satellite orbit errors, satellite clock errors, atmospherically influenced propagation time errors) are taken into consideration during the calibration process, so that only antenna-influenced reception errors remain in the GNSS signals.

A calibration process may have the following appearance in detail in this case. At a particular time, GNSS signals are first of all received from GNSS satellites, GNSS signals advantageously being received from more than four satellites (n>4) in this case. From these received GNSS signals of the individual satellites, what is known as a pseudo range is then ascertained for each satellite, said pseudo range initially including both satellite-influenced and atmospherically influenced inaccuracies and antenna-influenced inaccuracies.

In the next step, a correction for satellite-influenced and atmospherically influenced errors is then applied to the pseudo ranges, these satellite-influenced and atmospherically influenced error corrections being able to be ascertained by a reference station or a correction service consisting of multiple reference stations.

In the third step, the position (x, y, z) of the antenna at the time of reception of the GNSS signals is then ascertained from these pseudo ranges. Since more than four satellites have been received at the same time, this measurement is over-determined, i.e. the spheres around the satellites do not intersect exactly at one point (pseudo ranges), but rather prescribe a solution range. The best solution can then be determined using a method of compensation (for example Gaussian least squares). If the vehicle is moved by means of a rotating platform, for example, it will be possible for the step of position finding from the received GNSS signals to be dropped and for a known position to be introduced instead. This known position can be ascertained by means of a high-precision measurement in advance, for example, in which case it is particularly advantageous, for example, if the vehicle is moved by means of the movable platform such that the position of the antenna does not change. This is the case if the vehicle is rotated by means of a platform about an axis that runs through the antenna, for example.

Based on the ascertained or provided known position, it is then possible for a discrepancy (residues, which denote the defined portion of the variability that cannot be explained by the given model) to be determined for each satellite, these discrepancies indicating the antenna influence. As a basis for this, it is again possible for the GNSS signals or newly received GNSS signals to be used, multiple satellite measurements at the same time always being necessary in this case too, since the receiver time needs to be ascertained in every case.

In the case of iterative evaluation of the calibration data record, the corrections converge, so that applicable elevation- and azimuth-dependent error corrections for the

GNSS antenna can then be ascertained for each horizontal and/or vertical orientation of the vehicle over the whole time.

According to claim 8, a method for determining the position of a vehicle by means of a GNSS device of the vehicle is proposed therefor, the GNSS device having a GNSS antenna permanently installed in the vehicle, with elevation- and azimuth-dependent error corrections for calibrating the GNSS antenna being ascertained by the method as described above and stored in an error correction memory of the GNSS device.

To determine the position of the vehicle, the current vehicle position is first of all ascertained by means of the GNSS device (normally without correction of antenna-influenced errors), as is the horizontal and/or vertical vehicle orientation. Moreover, the satellite ephemerides are used to ascertain the respective satellite position of the satellites, so that the satellite angles (vertical angle and horizontal angle) in regard to the GNSS antenna of the vehicle can be computed for the respective satellite therefrom. Subsequently, the computed satellite angles are used to ascertain the relevant elevation- and azimuth-dependent error correction from the error correction memory, and said error correction is used to correct the distance measurement, so that the antenna-based error can be eliminated.

The orientation of the vehicle can in this case be ascertained either by additional sensors (such as a gyrocompass or second GNSS receiver, for example) or by a vehicle movement model, it being sufficient to assume for road or rail vehicles that the vehicle is oriented in the direction of the speed vector. The elevation- and azimuth-dependent error correction can be applied for the phase measurement and/or code measurement in this case.

The invention is explained in more detail by way of example on the basis of the accompanying FIGURE, in which:

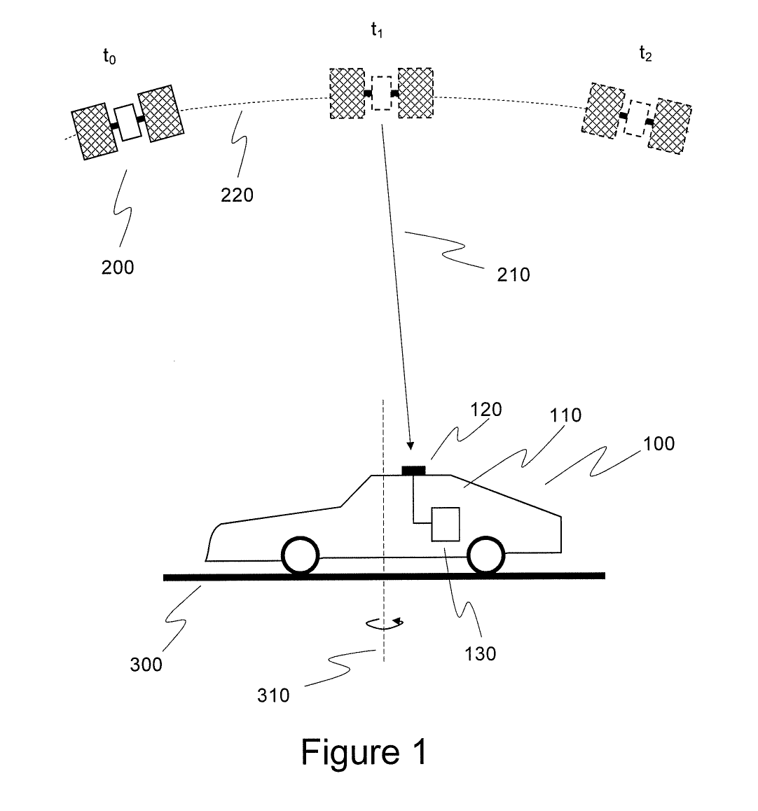

FIG. 1 shows an exemplary depiction of the method according to the invention.

FIG. 1 shows a vehicle 100 that has a GNSS device 110 having a GNSS antenna 120 and a computation unit 130.

In this case, the GNSS antenna 120 is permanently arranged on the vehicle 100 and is immobile relative to the vehicle. Only in conjunction with a movement of the vehicle 100 is the antenna 120 movable relative to other objects outside the vehicle 100.

The antenna 120 is configured to receive the GNSS signals 210 transmitted via a satellite 200, the computation unit 130 of the GNSS device 110 of the vehicle 100 being configured to take the received signals 210 as a basis for then performing a distance measurement to the satellite 200 and to take this distance measurement as a basis for then ascertaining the position of the vehicle 100 on the earth.

For the purpose of calibrating the antenna 120, the vehicle 100 is on a movable platform 300 that is rotatable about an axis 310. The vehicle 100 permanently arranged on the rotatable platform 300 would therefore, in the event of a rotary movement of the platform 300 about the axis 310, likewise also rotate about the axis, so that the vehicle carries out a rotary movement during which the horizontal orientation of the vehicle 100 continually changes. In the exemplary embodiment of FIG. 1, the vertical orientation of the vehicle relative to the earth's surface does not change in this case.

In the example of FIG. 1, only one satellite 200 is shown for reasons of clarity, said satellite transmitting applicable position signals 210 to determine the position of the vehicle 100. In practice, however, more than one satellite 200 is receivable in order to determine the position of the vehicle by means of appropriate triangulation.

The satellite 200 depicted is on an orbit 220 in this case, the satellite adopting a first position on the orbit 220 at the time t₀, adopting a position on the orbit 220 that has altered in comparison with the time t₀ at the time t₁ and adopting a further position on the orbit 220 at a last time t₂.

If the antenna 120 is to be calibrated together with the vehicle 100, then the vehicle 100 is first of all arranged on the platform 300 and rotated about the axis 310. During this time, the horizontal orientation of the vehicle constantly changes, so that the horizontal angle defined between the antenna 120 and the satellite 200 continually changes. If the vehicle is now rotated about the axis 310 by means of the platform 300 over several hours, then the satellite moves on its orbit 220 from the position at the time t₀ to the position at the time t₂, as a result of which the vertical angle between the antenna 120 and the satellite 200 also continually changes over time. Together with the rotary movement, regular changes in the vertical and horizontal angles are therefore produced over time, so that respective calibration measurements based on the GNSS signals received for applicable angles can be performed for different combinations of horizontal and vertical angles in order to calibrate the antenna.

For different horizontal and/or vertical orientations, a respective elevation- and azimuth-dependent error correction for the GNSS antenna is ascertained by the computation unit 130 on the basis of the respective horizontal and/or vertical orientation of the vehicle and a satellite position relative to the GNSS antenna 120, so that at the end of the calibration process at least one respective elevation- and azimuth-dependent error correction for the GNSS antenna is available for a multiplicity of combinations of vertical and horizontal angles.

For the calibration of the GNSS antenna 120, it is very advantageous in this case if GNSS signals are received for multiple satellites, preferably more than four satellites.

Based on the exemplary embodiment of FIG. 1, the elevation- and azimuth-dependent error correction can be ascertained by virtue of the position of the antenna and the position of the satellite on its orbit 220 being known, so that the specific distance between satellite 210 and antenna 120 is ascertainable at any time without any error. From the discrepancy in the standardized distance in regard to the measured distance in a specific case, it is then possible for an antenna error to be detected for each horizontal and vertical angle over time.

Alternatively, it is conceivable for the vehicle to travel along applicable figures relative to a local reference station, in which case the error ascertainment is also ascertained using the relative position in relation to the reference station.

### LIST OF REFERENCE SYMBOLS

100 Vehicle

110 GNSS device

120 GNSS antenna

130 Computation unit

200 GNSS satellite

210 GNSS signal

220 Orbit

300 movable platform

310 Axis of rotation

1. A method for calibrating a global navigation satellite system (GNSS) antenna of a vehicle, comprising:
providing a vehicle that has a vehicle-based GNSS device having a the GNSS antenna permanently installed in the vehicle for receiving GNSS signals of a GNSS satellite, and
performing a calibration process for calibrating the GNSS antenna permanently installed in the vehicle, wherein during the calibration process the vehicle is moved so that the horizontal and/or vertical orientation of the vehicle changes, and a respective elevation- and azimuth-dependent error correction for the GNSS antenna is computed for different horizontal and/or vertical orientations of the vehicle by a computation unit on the basis of GNSS signals of a GNSS satellite that are received in the respective horizontal and/or vertical orientation of the vehicle in order to be able to correct an antenna-influenced elevation- and azimuth-dependent error for the a GNSS position finding.

2. The method according to claim 1, wherein the computation unit computes an elevation- and azimuth-dependent error correction for a phase measurement and/or a code measurement for the GNSS position finding.

3. The method according to claim 1, wherein the vehicle is permanently positioned on a movable platform and is moved by the movable platform in order to change the horizontal and/or vertical orientation of the vehicle.

4. The method according to claim 1, wherein the vehicle is moved along a predetermined path.

5. The method according to claim 1, wherein the vehicle is moved along an undetermined path.

6. The method according to claim 1, wherein the horizontal and/or vertical orientation are ascertained by the vehicle-based GNSS device of the vehicle during moving of the vehicle, and the elevation- and azimuth-dependent error correction for the GNSS antenna is ascertained by the computation unit on the basis of the respective horizontal and/or vertical orientation of the vehicle ascertained by the GNSS device of the vehicle.

7. The method according to claim 1 wherein atmospherically influenced error corrections are ascertained by a correction data service for a current position of the vehicle and the atmospherically influenced error corrections are taken into consideration for calibration of the GNSS antenna.

8. A method for determining a the position of a vehicle by a GNSS device of the vehicle, wherein the vehicle has a GNSS antenna permanently installed in the vehicle, wherein elevation- and azimuth-dependent error corrections for calibrating the GNSS antenna by the method of claim 1 are ascertained and are stored in an electronic error correction memory, comprising:
ascertaining a current vehicle position, a horizontal and/or a vertical vehicle orientation, and a satellite position of a satellite,
computing satellite angles in regard to the GNSS antenna of the vehicle on the basis of the current vehicle position, the horizontal and/or the vertical vehicle orientation, and the respective satellite position of the satellite,
ascertaining an error correction from the elevation- and azimuth-dependent error corrections on the basis of the computed satellite angles, and
correcting a distance measurement for the GNSS position determination of the vehicle using the ascertained error correction.

9. The method according to claim 8, wherein a phase measurement and/or a code measurement is corrected by the ascertained error correction to correct the distance measurement.

10. A GNSS device for position determination for a vehicle having a GNSS antenna and an electronic error correction memory that includes elevation- and azimuth-dependent error corrections for calibrating the GNSS antenna produced using the method according to claim 1.

11. The GNSS device of claim 10 configured for
ascertaining a current vehicle position, a horizontal and/or a vertical vehicle orientation, and a satellite position of a satellite,
computing satellite angles in regard to the GNSS antenna of the vehicle on the basis of the current vehicle position, the horizontal and/or the vertical vehicle orientation, and the respective satellite position of the satellite,
ascertaining an error correction from the elevation- and azimuth-dependent error corrections on the basis of the computed satellite angles, and
correcting a distance measurement for the GNSS position determination of the vehicle using the ascertained error correction.

12. The method of claim 6 wherein a position of the vehicle is ascertained by the vehicle-based GNSS device of the vehicle during moving of the vehicle, and wherein the computation unit uses the ascertained position of the vehicle and a satellite position relative to the GNSS antenna in ascertaining the respective horizontal and/or vertical orientation of the vehicle.
